(19) United States
(12) Patent Application Publication
(10) Pub. No.: US 2016/0026252 A1
(43) Pub. Date: Jan. 28, 2016

(54) SYSTEM AND METHOD FOR GESTURE RECOGNITION

(71) Applicants: SONY CORPORATION, TOKYO (JP); SONY NETWORK ENTERTAINMENT INTERNATIONAL LLC, LOS ANGELES, CA (US)

(72) Inventors: Charles McCoy, Coronado, CA (US); True Xiong, San Diego, CA (US); Clay Fisher, San Diego, CA (US)

(21) Appl. No.: 14/444,066

(22) Filed: Jul. 28, 2014

(51) Int. Cl. G06F 3/01

(52) U.S. Cl. CPC G06F 3/017

(57) ABSTRACT

Various aspects of a system and a method for gesture recognition may comprise a server communicatively coupled to a plurality of devices. The server receives a plurality of gesture profiles associated with each of the one or more devices. The server determines a base gesture for a pre-defined gesture based on the received plurality of gesture profiles. The base gesture encapsulates a plurality of variations of the pre-defined gesture for a plurality of users associated with the plurality of devices.

### FIELD

Various embodiments of the disclosure relate to a system for gesture recognition. More specifically, various embodiments of the disclosure relate to a system and method for recognizing a gesture based on gestures associated with a plurality of users.

### BACKGROUND

People generally use various electronic devices every day. A user may interact with an electronic device via a user interface (UI). Examples of a user interface may include, but are not limited to, a key pad, an audio-based UI, a touch-based UI, and/or a gesture-based UI.

A gesture-based UI of an electronic device typically requires a user to configure various gestures to control different operations of the electronic device. When a user interacts with multiple electronic devices, the user may be required to individually configure gestures for each of the multiple electronic devices. This may be inconvenient to the user. Moreover, when multiple users interact with an electronic device, the electronic device may be required to store gesture profiles for each of the multiple users.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and a method for gesture recognition is described substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating gesture recognition in an exemplary network environment, in accordance with an embodiment of the disclosure.

FIG. 2 is a block diagram of an exemplary server for implementing the disclosed system and method, in accordance with an embodiment of the disclosure.

FIG. 3 is a block diagram of an exemplary device for gesture recognition, in accordance with an embodiment of the disclosure.

FIG. 4 illustrates an example of a base gesture associated with a gesture, in accordance with an embodiment of the disclosure.

FIG. 5 illustrates an example of various gesture inputs to devices by users, in accordance with an embodiment of the disclosure.

FIG. 6 is a flow chart illustrating exemplary steps for gesture recognition, in accordance with an embodiment of the disclosure.

### DETAILED DESCRIPTION

Various implementations may be found in a system and/or a method for gesture recognition. Exemplary aspects of a method for gesture recognition in a communication network may comprise a device. An input may be received by the device from a user associated with the device. A gesture associated with the received input may be identified based on one or more base gestures. Each of the one or more base gestures may encapsulate a plurality of variations of a pre-defined gesture for a plurality of users associated with the plurality of devices. The gesture associated with the received input may comprise a non-audio gesture.

The gesture may be identified as the pre-defined gesture when the received input matches at least one of the plurality of variations. The device may receive the one or more base gestures from a server communicatively coupled to the device. A change in one or more parameters associated with the gesture may be determined based on the received input. The determined change may be transmitted to the server. The one or more base gestures may be updated by the server, based on the determined change.

The one or more gesture profiles for one or more users associated with the device may be determined. The determined one or more gesture profiles may be transmitted to the server. The one or more base gestures may be determined by the server based on the one or more gesture profiles.

A base gesture profile may be received from the server. The received base gesture profile may comprise a base gesture for each device control operation associated with the device. The user may be enabled to configure, upload and/or restore a gesture profile corresponding to the user on the device through the server.

A base gesture of the received one or more base gestures may be set as a default gesture for a pre-defined device control operation. The pre-defined device control operation may be determined by the server based on a plurality of gesture profiles for the plurality of users.

Various implementations may be found in a system and/or a method for gesture recognition. Exemplary aspects of a method for gesture recognition in a communication network may comprise a server communicatively coupled to a plurality of devices. A plurality of gesture profiles associated with each of the plurality of devices may be received by the server. A base gesture for a pre-defined gesture may be determined based on the received plurality of gesture profiles. The base gesture may encapsulate a plurality of variations of the pre-defined gesture for a plurality of users associated with the plurality of devices. The pre-defined gesture may comprise a non-audio gesture.

A gesture performed by a user associated with one or more devices of the plurality of devices may be compared with the plurality of variations. The performed gesture may be determined as the pre-defined gesture when the performed gesture matches at least one of the plurality of variations. A base device control operation associated with the pre-defined gesture may be determined based on the received plurality of gesture profiles. A base gesture profile for each of the plurality of devices may be determined. The base gesture profile may comprise one or more base gestures corresponding to one or more device control operations of each of the plurality of devices.

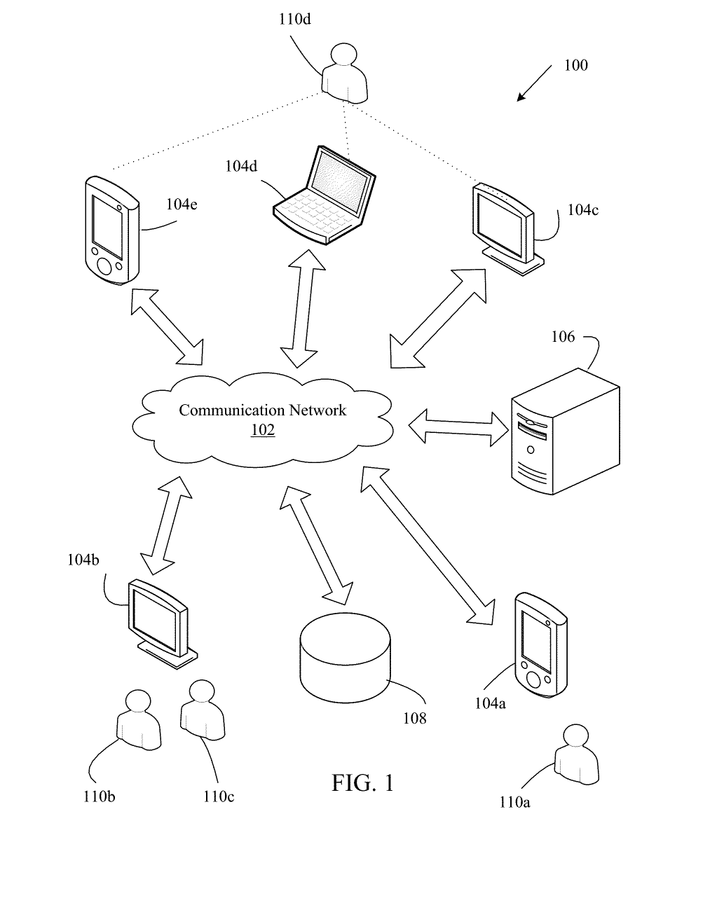

FIG. 1 is a block diagram illustrating gesture recognition in an exemplary network environment, in accordance with an embodiment of the disclosure. With reference to FIG. 1, there is shown a network environment 100. The network environment 100 may comprise a communication network 102 and one or more devices, such as a first device 104a, a second device 104b, a third device 104c, a fourth device 104d, and a fifth device 104e (collectively referred to as devices 104). The network environment 100 may further comprise a server 106 and a database 108. Although FIG. 1 illustrates five devices, the disclosure may not be so limited and the network environment 100 may include any number of devices, without limiting the scope of the disclosure.

The devices 104 may be associated with one or more users. In an embodiment, the first device 104a may be associated with a first user 110a. The second device 104b may be associated with a second user 110b and a third user 110c. In an embodiment, the third device 104c, the fourth device 104d, and the fifth device 104e may be associated with a fourth user 110d. The first user 110a, the second user 110b, the third user 110c, and the fourth user 110d will hereinafter be collectively referred to as users 110. Notwithstanding, the disclosure may not be so limited and any number of users may be associated with the devices 104, without limiting the scope of the disclosure.

The communication network 102 may include a medium through which the devices 104, the server 106, and the database 108 may communicate with each other. Examples of the communication network 102 may include, but are not limited to, the Internet, television broadcast network, satellite transmission, a cloud network, a Wireless Fidelity (Wi-Fi) network, a Wireless Local Area Network (WLAN), a Local Area Network (LAN), a telephone line (POTS), a Metropolitan Area Network (MAN), a Bluetooth network, a Wireless Fidelity (Wi-Fi) network, and/or a ZigBee network. Various devices in the network environment 100 may be operable to connect to the communication network 102, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, IEEE 802.16, cellular communication protocols, and/or Bluetooth (BT) communication protocols.

The devices 104 may correspond to an electronic device that may be controlled through a gesture-based user interface (UI). The devices 104 may comprise suitable logic, circuitry, interfaces, and/or code that may enable a user to control the devices 104 through a gesture-based UI. Examples of the devices 104 may include, but are not limited to, a television, a smartphone, a laptop, a tablet, a set-top box, a remote controller, and/or any consumer electronic device. Further examples of the devices 104 may include, but are not limited to, a public interactive kiosk, such as Internet kiosk, Ticketing kiosk, Automated Teller Machine (ATM), and/or security kiosk. Such public interactive kiosks may be located at public places, such as hospitals, hotel lobbies, airports, movie-theaters, railway stations, shopping malls, offices, and/or schools.

In an embodiment, the first device 104a may be a smartphone. The smartphone may be associated with a single user, such as the first user 110a. The second device 104b may be a television. The television may be associated with one or more users, such as the second user 110b and the third user 110c. In an embodiment, the television may be operated by each of the second user 110b and the third user 110c. In an embodiment, the third device 104c may be a television, the fourth device 104d may be a laptop, and the fifth device 104e may be a smartphone. The television, the laptop, and the smartphone may be associated with a single user, such as the fourth user 110d. In an embodiment, the fourth user 110d may operate each of the third device 104c, the fourth device 104d, and the fifth device 104e.

In an embodiment, the devices 104 may be controlled using a gesture-based UI. In an embodiment, users associated with the devices 104 may control various operations of the devices 104 by performing a gesture. In an embodiment, a gesture performed by a user associated with the devices 104 may comprise a non-audio gesture, an audio based gesture and/or a combination thereof. Examples of a non-audio gesture may include, but are not limited to, a touch-based gesture and/or visual-based gesture. For example, volume of a television may be controlled through a gesture associated with a hand movement. Examples of an audio based gesture performed by a user may include, but are not limited to, speech input, specific sounds, and/or specific words. For example, a user may change channels of a television by speaking the channel number.

In an embodiment, each of the devices 104 may store one or more gesture profiles associated with the device. In an embodiment, a gesture profile of a device may comprise one or more gestures, through which various operations of the device may be controlled. In an embodiment, a gesture profile of a device may comprise one or more non-audio gestures, audio based gestures and/or a combination thereof, through which various operations of the device may be controlled. For example, a first gesture profile associated with the first device 104a may comprise one or more gestures, through which the first user 110a may control various operations of the first device 104a.

In an embodiment, a gesture profile of a device may comprise one or more gestures that correspond to various users associated with the device. A gesture profile may comprise information associated with a manner in which a user performs a gesture. For example, a second gesture profile associated with the second device 104b may comprise gestures that correspond to each of the second user 110b and the third user 110c. The second user 110b may control various operations of the second device 104b via gestures of the second gesture profile that corresponds to the second user 110b. Similarly, the third user 110c may control various operations of the third device 104c through gestures of the second gesture profile that corresponds to the third user 110c. In an embodiment, a gesture profile associated with a user may comprise a plurality of variations of one or more gestures that the user may perform to control various device operations of the devices 104. The plurality of variations of a gesture may correspond to alternates ways in which the user may perform the gesture. The plurality of variations of a gesture may correspond to deviation of a gesture performed by the user from a standard gesture.

In an embodiment, the devices 104 may be associated with more than one user. In such a case, a different gesture profile may be associated with each of the users 110, associated with the devices 104. A gesture profile of a device may comprise different gesture profiles that correspond to each user associated with the device. For example, a second gesture profile of the second device 104b may comprise a gesture profile associated with each of the second user 110b and the third user 110c.

In an embodiment, the devices 104 may communicate with the server 106 via the communication network 102. The devices 104 may transmit their gesture profiles to the server 106.

The server 106 may comprise suitable logic, circuitry, interfaces, and/or code that may be operable to analyze gestures associated with the devices 104. The server 106 may be operable to receive a plurality of gesture profiles associated with the devices 104, from the devices 104. The server 106 may be operable to analyze the received plurality of gesture profiles. The server 106 may be operable to determine a base gesture for a pre-defined gesture, based on analysis of the received plurality of gesture profiles. A pre-defined gesture may correspond to a gesture that may be common to the users 110. A base gesture may encapsulate a plurality of variations of a pre-defined gesture for the users 110 associated with the devices 104. The server 106 may be operable to determine a base gesture profile for each of the devices 104, based on analysis of the received plurality of gesture profiles. A base gesture profile may comprise one or more base gestures that correspond to one or more operations of each of the devices 104.

In an embodiment, the server 106 may be associated with a website. In an embodiment, the website may correspond to a website of a device manufacturer. The server 106 may publish gesture profiles received from the devices 104 on a website associated with the server 106. The server 106 may publish a base gesture associated with a pre-defined gesture and a base gesture profile, on a website associated with the server 106. The users 110 may access a website associated with the server 106 to upload and/or restore gesture profiles associated with the devices 104, a base gesture for a pre-defined gesture, and/or a base gesture profile.

The database 108 may comprise suitable logic, circuitry, interfaces, and/or code that may be operable to store data. Examples of data stored in the database 108 may include, but are not limited to, one or more gesture profiles received from the devices 104, a base gesture associated with a pre-defined gesture, a base gesture profile, configuration information of the devices 104, and/or profiles associated with the users 110. A profile associated with a user may include various information of the user. Examples of such information may include, but are not limited to, name, age, sex, geographic location, education, likes, dislikes, email address, social networking contacts, list of devices associated with the user, configuration settings of devices associated with user, and/or gesture profile associated with the user. In an embodiment, the database 108 may be integrated within the server 106. The database 108 may be implemented using several technologies that are well known to those skilled in the art.

In an embodiment, the database 108 may store gesture profiles used to control various operations of the devices 104. The database 108 may store gesture profiles of the users 110 associated with the devices 104.

In an embodiment, the database 108 may store a gesture profile of one or more users associated with a particular device. For example, the database 108 may store gesture profile of the first user 110a associated with the first device 104a. In another example, the database 108 may store gesture profiles of each of the second user 110b and the third user 110c associated with the second device 104b. In an embodiment, the database 108 may store a plurality of gesture profiles of one or more devices associated with a particular user. For example, the database 108 may store gesture profiles for each of the third device 104c, the fourth device 104d, and the fifth device 104e, all of which are associated with the fourth user 110d. In an embodiment, the database 108 may maintain backup data of various gesture profiles of the users 110.

In operation, each of the devices 104 may determine one or more gesture profiles for the users 110. Each of the devices 104 may communicate with the server 106, via the communication network 102. The devices 104 may transmit a gesture profile associated with the devices 104, to the server 106. The server 106 may store gesture profiles received from the devices 104. In an embodiment, the server 106 may locally store the gesture profiles received from the devices 104. In an embodiment, the server 106 may store the gesture profiles received from the devices 104 in the database 108. The server 106 may transmit the received gesture profiles to the database 108, via the communication network 102.

The server 106 may analyze gesture profiles received from the devices 104. In an embodiment, based on the analysis of the received gesture profiles, the server 106 may determine a base gesture that corresponds to a pre-defined gesture. A base gesture may encapsulate a plurality of variations of a pre-defined gesture for the users 110 associated with the devices 104. For example, a hand-movement gesture, performed by different users, may vary in speed and/or angle at which that the different users move their hand. The server 106 may determine a base gesture for such a hand-movement gesture. The base gesture for the hand-movement gesture may encapsulate variations in speed and/or angle at which the different users move their hand.

In an embodiment, based on the analysis of the received gesture profiles, the server 106 may determine a base gesture profile for each of the devices 104. A base gesture profile may comprise one or more base gestures that correspond to one or more control operations of each of the devices 104.

In an embodiment, the server 106 may set a default device control operation that corresponds to a base gesture. The server 106 may transmit one or more base gestures to the devices 104, via the communication network 102. The server 106 may transmit one or more default device control operations that correspond to the one or more base gestures to the devices 104, via the communication network 102. The server 106 may transmit one or more base gesture profiles to the devices 104, via the communication network 102. Each of the devices 104 may set a base gesture, received from the server 106, as a default gesture to control a pre-defined operation of each of the devices 104.

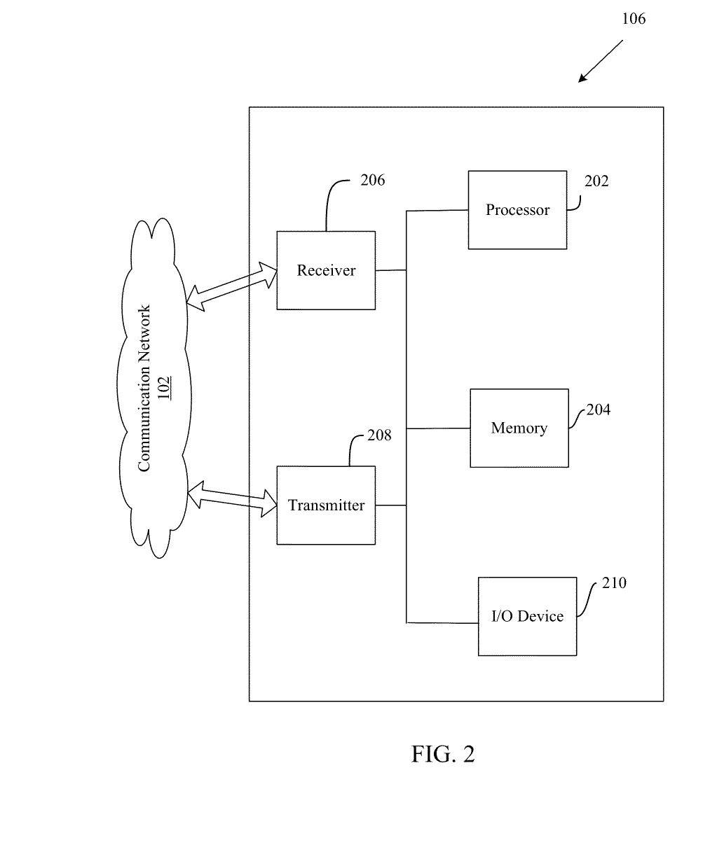

FIG. 2 is a block diagram of an exemplary server for implementing the disclosed system and method, in accordance with an embodiment of the disclosure. FIG. 2 is explained in conjunction with elements from FIG. 1. With reference to FIG. 2, there is shown the server 106. The server 106 may comprise one or more processors, such as a processor 202, a memory 204, and a receiver 206, a transmitter 208, and an input/output (I/O) device 210.

The processor 202 may be communicatively coupled to the memory 204. The receiver 206 and the transmitter 208 may be communicatively coupled to the processor 202, the memory 204, and the I/O device 210.

The processor 202 may comprise suitable logic, circuitry, and/or interfaces that may be operable to execute at least one code section stored in the memory 204. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The memory 204 may comprise suitable logic, circuitry, interfaces, and/or code that may be operable to store a machine code and/or a computer program that has at least one code section executable by the processor 202. Examples of implementation of the memory 204 may include, but are not limited to, Random Access Memory (RAM), Read Only Memory (ROM), Hard Disk Drive (HDD), and/or a Secure Digital (SD) card. The memory 204 may be operable to store data. The memory 204 may be operable to store configuration information of the devices 104. The memory 204 may be operable to store one or more algorithms that analyze and process gesture profiles associated with the devices 104. The memory 204 may store one or more base gestures, and/or one or more base gesture profiles, determined by the server 106. The memory 204 may store one or more profiles associated with the users 110. The memory 204 may further store other data.

The receiver 206 may comprise suitable logic, circuitry, interfaces, and/or code that may be operable to receive data and messages. The receiver 206 may receive data in accordance with various known communication protocols. In an embodiment, the receiver 206 may receive one or more signals transmitted by the devices 104 and/or the database 108. In an embodiment, the receiver 206 may receive one or more gesture profiles associated with the devices 104, from the devices 104. For example, the receiver 206 may receive a signal that corresponds to a sliding movement of a hand, performed by the first user 110a on the first device 104a. In an embodiment, the receiver 206 may receive a request from the devices 104 for a base gesture and/or a base gesture profile. The receiver 206 may implement known technologies to support wired or wireless communication between the server 106, the devices 104, and the database 108.

The transmitter 208 may comprise suitable logic, circuitry, interfaces, and/or code that may be operable to transmit data and/or messages. The transmitter 208 may transmit data, in accordance with various known communication protocols. In an embodiment, the transmitter 208 may transmit one or more signals to the devices 104. In an embodiment, the transmitter 208 may transmit a base gesture and/or a base gesture profile, to the devices 104. The transmitter 208 may include, but is not limited to, an antenna, one or more amplifiers, a tuner, one or more oscillators, a digital signal processor, a coder-decoder (CODEC) chipset, a subscriber identity module (SIM) card, and/or a local buffer. The transmitter 208 may communicate with the devices 104 and/or the database 108, via wired or wireless communication networks.

The I/O device 210 may comprise various input and output devices that may be operably coupled to the processor 202. The I/O device 210 may comprise suitable logic, circuitry, interfaces, and/or code that may be operable to receive input from a user operating the server 106 and provide an output. Examples of input devices may include, but are not limited to, a keypad, a stylus, a microphone, and/or a touch screen. Examples of output devices may include, but are not limited to, a display and/or a speaker.

In operation, the processor 202 may receive a plurality of gesture profiles associated with the devices 104, from the devices 104. In an embodiment, the processor 202 may determine a base gesture profile based on analysis of the received gesture profiles. The processor 202 may transmit the determined base gesture and the determined base gesture profile to the devices 104.

In an embodiment, a gesture profile received by the processor 202, from one of the devices 104, may comprise one or more gestures that a user may perform to control various operations of the device. In an embodiment, one or more gestures included in a gesture profile received from the devices 104 may comprise a non-audio gesture, an audio based gesture and/or a combination thereof. For example, the processor 202 may receive a first gesture profile from the first device 104a, which is a smartphone in the exemplary embodiment. The first gesture profile may comprise gestures, through which the first user 110a may control operations of the smartphone. For example, the first gesture profile of the first device 104a (the smartphone) may include gestures such as, but not limited to, moving hands to draw a “X” pattern to unlock the smartphone and/or waving a hand to answer an incoming call. The first gesture profile of the first device 104a (the smartphone) may further include gestures such as, but not limited to, making a pinch action to zoom images, and/or moving a finger from right to left to scroll web pages.

Similarly, the processor 202 may receive a second gesture profile associated with the second user 110b, from the second device 104b, which is a television. The processor 202 may further receive a third gesture profile associated with the third user 110c, from the second device 104b. The second gesture profile may comprise gestures through which the second user 110b may control operations of the television. The third gesture profile may comprise gestures through which the third user 110c may control operations of the television. In an embodiment, gestures performed by the second user 110b, to control an operation of the second device 104b, may differ from that performed by the third user 110c, to control the operation of the second device 104b. In an embodiment, gestures performed by the second user 110b, to control an operation of the second device 104b, may be same as that performed by the third user 110c, to control the operation of the second device 104b. The second gesture profile and/or the third gesture profile may include gestures such as, but not limited to, moving hands to draw an “X” pattern to turn-off the television, waving a hand to control volume, moving hands to draw a tick mark to make a selection, and/or moving a finger from right to left to change channels. In an embodiment, the processor 202 may receive a single gesture profile from the second device 104b. The single gesture profile associated with the second device 104b may classify various gestures as being performed by the second user 110b, and the third user 110c.

Similarly, the processor 202 may receive gesture profiles associated with the third device 104c, the fourth device 104d, and the fifth device 104e, from the respective devices. Each of the received gesture profiles may comprise gestures through which the fourth user 110d may control operations of the respective device. For example, the received gesture profiles may include gestures such as, but not limited to, moving hands to draw an “X” pattern to turn-off the television and/or shutdown the laptop, waving a hand to control volume of the television, laptop and/or the smartphone, moving hands to draw a tick mark to make a selection, and/or moving a finger from right to left to change channels of the television. Notwithstanding, the disclosure may not be so limited and gesture profiles received from the devices 104 may include other gestures, without limiting the scope of the disclosure.

In an embodiment, the processor 202 may analyze the plurality of gesture profiles received from the devices 104. The processor 202 may compare various gesture profiles received from the devices 104. The processor 202 may compare various gestures included in the gesture profiles received from the devices 104. Based on the comparison, the processor 202 may determine variations that may occur when the users 110 perform a particular gesture. In an embodiment, based on the analysis, the processor 202 may determine a base gesture that corresponds to a pre-defined gesture. In an embodiment, a base gesture associated with a pre-defined gesture may encapsulate a plurality of variations of the pre-defined gesture for the users 110. In an embodiment, a plurality of variations of a pre-defined gesture encapsulated by a base gesture may correspond to multiple alternative ways by which the pre-defined gesture may be performed by the users 110. For example, the processor 202 may determine that the first user 110a may end a specific gesture by reversing the direction in which the finger is moving. The processor 202 may determine that the second user 110b may end the same specific gesture by moving the finger in a circle at the end of the specific gesture. In such a case, the processor 202 may define a base gesture associated with the specific gesture such that the base gesture encapsulates both the ways of performing the specific gesture.

In an embodiment, a plurality of variations of a pre-defined gesture encapsulated by a base gesture may correspond to deviation of specifications associated with the gesture from a standard gesture. Examples of such specifications may include, speed, angle, and/or curvature at which a gesture is performed. For example, the processor 202 may determine variations that may occur when the users 110 perform a gesture by moving a hand from left to right. The processor 202 may determine that the speed at which the users 110 may move the hand differs for each user. For example, the first user 110a may move the hand at a speed more than the speed at which the second user 110b may move the hand. In another example, the processor 202 may determine that at the time of hand movement, position of the hand with respect to the ground may be different for each of the users 110. For example, while moving the hand, the third user 110c may keep the hand parallel to the ground while the fourth user 110d may keep the hand inclined with respect to ground. Based on the determined variations in speed and/or hand position, the processor 202 may determine a base gesture for hand movement. The base gesture for hand movement may encapsulate variations of hand movement performed by the users 110 with different speed and/or hand positions. Similarly, the processor 202 may determine a base gesture for other gestures, such as drawing a pattern, performing a pinch action, and/or waving a hand, based on variations and/or alternate ways of performing the other gestures. In an embodiment, the processor 202 may interpret variations and/or alternate ways that correspond to a base gesture of a pre-defined gesture to have the same meaning. In an embodiment, the processor 202 may recognize that a user is performing a particular gesture when the processor 202 identifies any of the variations and/or alternate ways associated with base gesture that correspond to the particular gesture. The processor 202 may store the determined base gesture locally in the memory 204 and/or in the database 108. As a result, the processor 202 may create a repository that includes variations and/or alternate ways that correspond to different gestures for various users.

In an embodiment, the processor 202 may utilize a repository of base gestures associated with different gestures to identify an unknown gesture performed by a user. In an embodiment, the processor 202 may receive an unknown gesture from a device of the devices 104. The processor 202 may compare the received unknown gesture with base gestures. The processor 202 may compare the received unknown gesture with variations and/or alternate ways associated with different base gestures. Based on the comparison, the processor 202 may determine whether the received unknown gesture matches any of the variations and/or alternate ways associated with different base gestures. When the received unknown gesture matches a variation and/or an alternate way of a particular base gesture associated with a pre-defined gesture, the processor 202 may determine the unknown gesture as the pre-defined gesture. For example, the processor 202 may compare a gesture performed by the first user 110a with variations and/or alternate ways of a base gesture associated with a hand movement. The processor 202 may determine that speed and/or hand position associated with the gesture performed by the first user 110a matches at least one speed and/or hand position variations of the base gesture associated with hand movement. In such a case, the processor 202 may determine the gesture performed by the first user 110a as a correct hand movement. In an embodiment, the processor 202 may transmit information associated with a base gesture that is determined to correspond to the unknown gesture to the device that has transmitted the unknown gesture to the processor 202. In an embodiment, an unknown gesture may not match any variations and/or alternate ways of any base gestures. The processor 202 may transmit an error message to a device that has transmitted the unknown gesture to the processor 202. The processor 202 may store the unknown gesture as a new gesture.

In an embodiment, the processor 202 may provide feedback to the devices 104 with regard to identification of a gesture. In an embodiment, the processor 202 may determine that the devices 104 have incorrectly identified a gesture input to the devices 104. In such a case, the processor 202 may transmit a message to the devices 104 indicating the error. The message may further indicate a correct gesture associated with the input gesture. The processor 202 may determine the correct gesture based on analysis of gesture profiles of the users 110.

In an embodiment, the processor 202 may determine a base device control operation associated with a gesture based on analysis of gesture profiles received from the devices 104. Based on the analysis, the processor 202 may further determine a device control operation associated with each gesture of the gesture profiles received from the devices 104. The processor 202 may determine which device control operation is most commonly controlled by a pre-defined gesture. In an embodiment, the processor 202 may determine a device control operation as most common when a number of users that perform the device control operation exceed a predetermined threshold. For example, if more than 50% of users draw a tick mark as a gesture for making a selection, the processor 202 may determine making a selection is the most common device control operation associated with drawing a tick mark.

In an embodiment, the processor 202 may define a most common device operation controlled by a pre-defined gesture as a base device control operation associated with the pre-defined gesture. In an embodiment, the processor 202 may define a base device control operation that corresponds to a base gesture associated with the pre-defined gesture. For example, based on the analysis of gesture profiles associated with the devices 104, the processor 202 may determine that a most common device control operation associated with a gesture of making a pinch action is to control zoom of images. In such a case, the processor 202 may define control of zoom of images as a base device control operation associated with the pinch action. In another example, the processor 202 may determine most of the users move their finger from right to left to scroll web pages. In such a case, the processor 202 may determine scrolling web pages as a base device control operation that corresponds to movement of fingers from right to left.

In an embodiment, the processor 202 may set a base device control operation as a default device control operation that corresponds to a base gesture associated with a pre-defined gesture. The processor 202 may transmit a default device control operation to the devices 104. The devices 104 may implement a default device control operation, such that when a user performs the pre-defined gesture, the default device control operation is executed. For example, for the first device 104a, the processor 202 may set scrolling web pages as a default device control operation that corresponds to movement of fingers from right to left. In such a case, when the first user 110a moves fingers from right to left, the first device 104a executes an operation of scrolling web pages. In another example, when a hand is waved, the processor 202 may set a channel change operation as a default device control operation. The processor 202 may transmit the set default device control operation to the fourth device 104d, which is a television. The fourth device 104d may execute a channel change operation when the fourth user 110d waves a hand to control the fourth device 104d.

In an embodiment, the processor 202 may determine a most common gesture that corresponds to a pre-defined operation of a device based on analysis of gesture profiles received from the devices 104. The processor 202 may set the most common gesture as a default gesture that corresponds to the pre-defined operation of the device. For example, the processor 202 may determine that most of the users 110 use movement of a finger in the vertical direction to control volume of a television. The processor 202 may set vertical movement of a finger as a default, gesture that corresponds to volume control of a television.

In an embodiment, the processor 202 may determine a base gesture profile for each of the devices 104. A base gesture profile for a device may comprise one or more base gestures that correspond to one or more device control operations of the device. In an embodiment, the processor 202 may determine a default base gesture for each device control operation, on the basis of a most common gesture that corresponds to each device control operation. The processor 202 may determine a base gesture profile based on the determined default base gestures for each of the device control operations. For example, a base gesture profile for a television may include various, gestures that control different operations of the television. Examples of the gestures that control different operations of the television may include, but are not limited to, waving a hand to turn on the television, sliding a finger from left to right to control volume of the television, moving a hand in vertical direction to change channels, drawing a tick mark to select a channel, and/or drawing cross mark to turn off the television.

In an embodiment, the processor 202 may determine a same base gesture profile for the same type of devices, irrespective of a manufacturer associated with the devices. For example, the processor 202 may determine a same base gesture profile for all televisions (such as the second device 104b and the third device 104c). In an embodiment, the processor 202 may transmit a base gesture profile to the devices 104. The devices 104 may implement the received base gesture profile, such that the users 110 may control the devices 104 through gestures associated with the received base gesture profile.

In an embodiment, the processor 202 may receive updated gesture profiles from the devices 104. In an embodiment, the processor 202 may receive updated gesture profiles from the devices 104 periodically at a predetermined time interval. In an embodiment, the predetermined time interval may be defined by the users 110 associated with the devices 104. In an embodiment, the processor 202 may receive updated gesture profiles from the devices 104 in real time. In an embodiment, the processor 202 may receive updated gesture profiles from the devices 104 based on fulfillment of pre-defined criteria. For example, a device may determine that gestures performed by a user associated with the device have changed over time from their previous performances. In such a case, the device may transmit the updated gesture profile to the processor 202. In an embodiment, the processor 202 may dynamically update base gesture and a default device control operations that correspond to a base gesture, based on the updated gesture profiles received from the devices 104. Notwithstanding, the disclosure may not be so limited and the processor 202 may receive an updated gesture profile from the devices 104 based on other criteria, without limiting the scope of the disclosure. In an embodiment, the processor 202 may dynamically update a base gesture profile for each of the devices 104, based on the updated gesture profiles received from the devices 104.

In an embodiment, the processor 202 may determine a change in one or more received gesture profiles as compared to previously received gesture profiles. The processor 202 may determine the change based on analysis of one or more gesture profiles received from the devices 104. For example, the processor 202 may determine that a gesture profile received from a device, such as first device 104a, may include a new gesture. In such a case, the processor 202 may determine whether the new gesture is another variation of a pre-defined gesture. Another variation of a pre-defined gesture refers to a variation of the pre-defined gesture which is different from a plurality of variations already encapsulated in a base gesture of the pre-defined gesture. In an embodiment, when a new gesture is another variation of a pre-defined gesture, the processor 202 may dynamically update the base gesture associated with the pre-defined gesture to include the new gesture as another variation of the pre-defined gesture. When a new gesture is not another variation of a pre-defined gesture, the processor 202 may determine a new base gesture that corresponds to the new gesture. In an embodiment, the processor 202 may determine that a new gesture is another variation of a pre-defined gesture based on degree of similarity of the new gesture with a plurality of variations already encapsulated in a base gesture of the pre-defined gesture. In an embodiment, the processor 202 may determine that a new gesture is another variation of a pre-defined gesture when difference between the new gesture and any of the plurality of variations already encapsulated in a base gesture of the pre-defined gesture is within a pre-defined range. Notwithstanding, the disclosure may not be so limited and the processor 202 may determine a new gesture as another variation of a pre-defined gesture using other techniques, without limiting the scope of the disclosure.

In an embodiment, the processor 202 may store one or more gesture profiles received from the devices 104, a set of base gestures, and/or base gesture profiles for the devices 104 in the database 108. In an embodiment, the processor 202 may allow the users 110 to access the stored gesture profiles associated with the devices 104, the set of base gestures, and/or base gesture profiles for the devices 104, via a website associated with the processor 202. Examples of such a website may be a website of a device manufacturer. In an embodiment, the users 110 may access the website through the devices 104. In an embodiment, the processor 202 may provide a UI to the devices 104, through which a user may provide user credentials associated with the website. The processor 202 may allow the users 110 to login to the website when user credentials are authenticated. Subsequent to login to the website, the processor 202 may allow the users 110 to access the stored gesture profiles associated with the devices 104, the set of base gestures, and/or base gesture profiles for the devices 104. In an embodiment, the processor 202 may allow the users 110 to upload and/or install a base gesture profile on a device. For example, the first user 110a may add a new device (such as a laptop) to the network environment 100. In such a case, the first user 110a may install a gesture profile associated with the first user 110a onto the new laptop, via a website associated with the processor 202. Similarly, the first user 110a may install a base gesture profile associated with a laptop on the new laptop via a website associated with the processor 202. In another example, the second user 110b may format the laptop. In such a case, the second user 110b may restore a gesture profile on the laptop that may have been formatted via a website associated with the processor 202.

In an embodiment, the processor 202 may allow the users 110 to modify one or more configurations determined by the processor 202. Examples of such configurations may include, but are not limited to, a base gesture associated with a gesture, a base gesture profile associated with the devices 104, and/or a base device control operation associated with a gesture. Examples of such configurations may further include, but are not limited to, a default device control operation associated with a base gesture and/or a default gesture associated with a pre-defined operation of the devices 104. In an embodiment, the processor 202 may allow the users 110 to modify one or more configurations determined by the processor 202 via a website associated with the processor 202.

In an embodiment, the processor 202 may classify the users 110 based on similarities between gesture profiles of the users 110. For example, the processor 202 may determine a common pattern between gestures of the users 110 based on their age, geographic location, education, and/or other factors. The processor 202 may further determine a common pattern according to months, days, and/or time of the day. For example, the processor 202 may determine that the users 110 may perform a particular gesture more slowly on weekends as compared to weekdays. The processor 202 may create user groups based on the common patterns. In an embodiment, the processor 202 may recommend a base gesture to a user of a user group based on gestures associated with other users of the user group. In an embodiment, the processor 202 may recommend a base gesture profile to a device based on a user group of a user associated with the device. In an embodiment, the processor 202 may define a base gesture for a user group based on gestures common between the users of the user group.

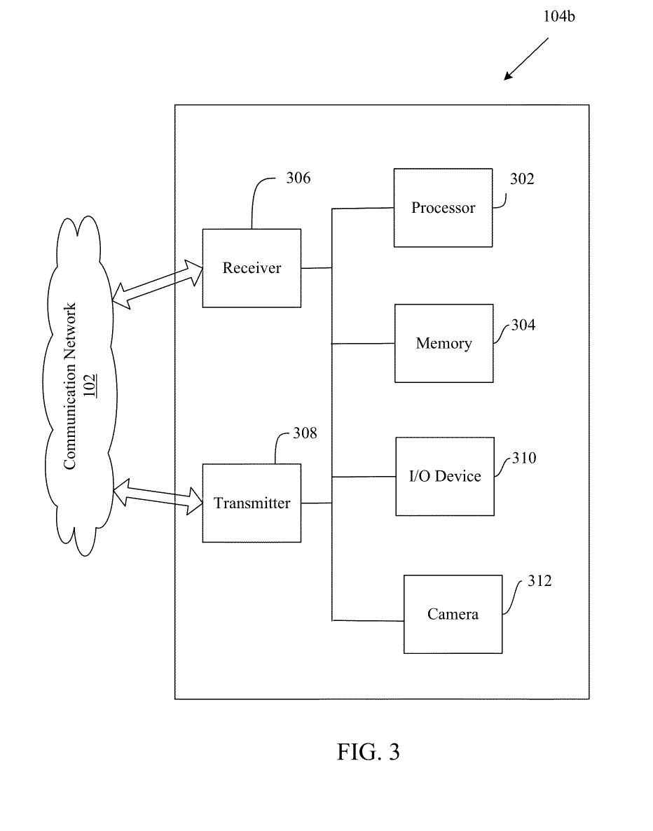

FIG. 3 is a block diagram of an exemplary device for gesture recognition, in accordance with an embodiment of the disclosure. The block diagram of FIG. 3 is explained in conjunction with elements from FIG. 1 and FIG. 2. With reference to FIG. 3, there is shown the second device 104b. Although the device shown in FIG. 3 corresponds to the second device 104b, the disclosure is not so limited. A device of FIG. 3 may also correspond to the first device 104a, the third device 104c, the fourth device 104d, or the fifth device 104e, without limiting the scope of the disclosure.

The second device 104b may comprise one or more processors, such as a processor 302, a memory 304, a receiver 306, a transmitter 308, an input/output (I/O) device 310, and a camera 312.

The processor 302 may be communicatively coupled to the memory 304 and the I/O device 310. The receiver 306 and the transmitter 308 may be communicatively coupled to the processor 302, the memory 304 and the I/O device 310.

The processor 302 may comprise suitable logic, circuitry, and/or interfaces that may be operable to execute at least one code section stored in the memory 304. The processor 302 may be implemented based on a number of processor technologies known in the art. Examples of the processor 302 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The memory 304 may comprise suitable logic, circuitry, interfaces, and/or code that may be operable to store a machine code and/or a computer program having at least one code section executable by the processor 302. Examples of implementation of the memory 304 may include, but are not limited to, Random Access Memory (RAM), Read Only Memory (ROM), Hard Disk Drive (HDD), and/or a Secure Digital (SD) card. The memory 304 may be operable to store data, such as configuration settings of the second device 104b. The memory 304 may further store gesture profiles of one or more users associated with the second device 104b (hereinafter referred to as second device user). For example, the memory 304 may store a gesture profile of the second user 110b and the third user 110c associated with the second device 104b. The memory 304 may further store one or more algorithms that analyze and process gesture profiles of second device users. The memory 304 may store a base gesture and/or a base gesture profile received from the server 106.

The receiver 306 may comprise suitable logic, circuitry, interfaces, and/or code that may be operable to receive data and messages. The receiver 306 may receive data in accordance with various known communication protocols. In an embodiment, the receiver 306 may receive a base gesture and/or a base gesture profile from the server 106. In an embodiment, the receiver 306 may receive a base device control operation from the server 106. The receiver 306 may implement known technologies for supporting wired or wireless communication between the server 106 and the second device 104b.

The transmitter 308 may comprise suitable logic, circuitry, interfaces, and/or code that may be operable to transmit data and/or messages. The transmitter 308 may transmit data, in accordance with various known communication protocols. In an embodiment, the transmitter 308 may transmit a gesture profile associated with the second device 104b to the server 106. In an embodiment, the transmitter 308 may transmit information associated with a gesture performed by a second device user to the server 106.

The I/O device 310 may comprise various input and output devices that may be operably coupled to the processor 302. The I/O device 310 may comprise suitable logic, circuitry, interfaces, and/or code that may be operable to receive an input from a second device user. The I/O device 310 may comprise suitable logic, circuitry, interfaces, and/or code that may be operable to provide an output. Examples of input devices may include, but are not limited to, a keypad, a stylus, a microphone, and/or a touch screen. Examples of output devices may include, but are not limited to, a display and/or a speaker.

The camera 312 may correspond to an electronic device capable of capturing and/or processing an image. The camera 312 may comprise suitable logic, circuitry, interfaces, and/or code that may be operable to capture an image. In an embodiment, the camera 312 may capture images of a second device user when the second device user performs a gesture.

In operation, a second device user (such as the second user 110b) may provide a gesture input to control the second device 104b. For example, a second device user may perform a gesture to control the second device 104b. The processor 302 may recognize the gesture performed by the second device user. The processor 302 may determine a device control operation that corresponds to the gesture performed by the second device user. The processor 302 may implement the determined device control operation.

In an embodiment, the processor 302 may receive an input from a second device user based on images captured by the camera 312. The camera 312 may capture a series of images of the second device user when the second device user performs the gesture. For example, when the second user 110b waves a hand, the camera 312 may capture a series of images that show different positions of the hand. The processor 302 may process the series of images captured by the camera 312 to identify a gesture performed by the second user 110b. Notwithstanding, the disclosure may not be so limited and the processor 302 may identify the gesture performed by the second user 110b using other techniques, without limiting the scope of the disclosure.

In an embodiment, the processor 302 may determine a gesture profile for each second device user. The processor 302 may store a gesture profile for each second device user in the memory 304. For example, the processor 302 may store a second gesture profile associated with the second user 110b, and a third gesture profile associated with the third user 110c. Gesture profiles associated with the second user 110b and the third user 110c, have been described above with regard to FIG. 1 and FIG. 2. In an embodiment, the processor 302 may allow a second device user to define a gesture profile associated with the second device user. In an embodiment, the processor 302 may determine a gesture profile based on machine learning algorithms.

In an embodiment, a gesture profile for a second device user may include various gestures through which the second device user may control the second device 104b. In an embodiment, a gesture profile for a second device user may comprise audio gestures, non-audio gestures and/or a combination thereof. In an embodiment, a gesture profile for a second device user may include a plurality of variations for each gesture included in the gesture profile for the second device user. The plurality of variations of a gesture may correspond to multiple alternative ways of performing the gesture and/or deviation of specifications associated with the gesture from a standard gesture. Examples of such specifications may include, speed, angle, and/or curvature at which a gesture is performed. In an embodiment, a standard gesture may be defined by a user at a time of configuring a device.

In an embodiment, the processor 302 may determine variations of a gesture that may occur when a second device user performs a gesture. For example, every time the second user 110b performs a gesture, such as waving a hand, the processor 302 may determine specifications associated with the gesture. The processor 302 may determine that specifications of a gesture may deviate from a standard gesture every time the second device user performs that gesture. In another example, when the second device user moves a hand, the processor 302 may determine that the second device user may initiate the hand movement in different ways. As a result, the processor 302 may determine variations for a gesture performed by the second device user. The processor 302 may store a plurality of variations associated with a gesture in the memory 304.

In an embodiment, a plurality of users (such as the second user 110b and the third user 110c) may be associated with the second device 104b. In such a case, the processor 302 may determine variations for a gesture based on performance of the gesture by the plurality of second device users. For example, the processor 302 may determine variations that may occur when the second user 110b and the third user 110c draws a checkmark pattern. The processor 302 may include the variations in the second gesture profile and the third gesture profile.

In an embodiment, when variations for a gesture performed by the second device user are within a pre-defined range, the processor 302 may interpret that all the variations imply the same gesture. In such a case, the processor 302 may determine that the second device user is performing the same gesture, even if the performed gesture differs from a standard gesture. For example, the processor 302 may determine that a speed and/or an angle at which the second user 110b waves the hand may differ slightly every time. When the speed variations do not exceed a pre-defined range, the processor 302 may determine that the second user 110b intends to perform the same hand-waving gesture.

In an embodiment, the processor 302 may identify a pattern between a plurality of variations of a gesture associated with a second device user. Such patterns may be based on the time at which the second device user performs the gesture and/or other factors. For example, the processor 302 may determine that the third user 110c performs a gesture slowly for the first few attempts, but may perform the same gesture faster after performing the gesture for a certain number of times. The processor 302 may include such patterns in a gesture profile of a second device user.

In an embodiment, the processor 302 may determine a gesture profile associated with the second device 104b. A gesture profile associated with the second device 104b may include one or more gestures associated with various device control operations of the second device 104b, as explained above with regard to FIG. 2. In an embodiment, a gesture profile associated with the second device 104b may be defined by a manufacturer of the second device 104b. Such a gesture profile may be set as a default gesture profile associated with the second device 104b. In an embodiment, the processor 302 may allow a second device user to define a gesture profile associated with the second device 104b. In an embodiment, the processor 302 may allow a second device user to modify a default gesture profile associated with the second device 104b.

In an embodiment, the processor 302 may transmit a gesture profile of a second device user to the server 106. For example, the processor 302 may transmit a gesture profile of the second user 110b and the third user 110c associated with the second device 104b to the server 106. In an embodiment, the processor 302 may transmit a gesture profile associated with the second device 104b to the server 106.

In an embodiment, the processor 302 may determine a change in a gesture profile of a second device user based on a change in a gesture associated with the gesture profile. In an embodiment, the processor 302 may determine that configuration of a gesture performed by a second device user may change over time from their previous performances of the gesture. In such a case, the processor 302 may update a gesture profile associated with the second device user. For example, the processor 302 may determine that the speed at which the third user 110c moves a finger from right to left has increased overtime. The processor 302 may update the third gesture profile associated with the third user 110c to include the increased speed. In another embodiment, the processor 302 may identify a new gesture performed by the second user 110b. The processor 302 may update the second gesture profile associated with the second user 110b to include the new gesture. In an embodiment, the processor 302 may determine a change in a gesture profile associated with the second device 104b. The processor 302 may transmit an updated gesture profile to the server 106.

In an embodiment, the processor 302 may receive a base gesture associated with a pre-defined gesture from the server 106. The base gesture may encapsulate a plurality of variations of the pre-defined gesture for the users 110. In an embodiment, the processor 302 may set received base gestures associated with various gestures as reference gestures for those gestures. In an embodiment, default reference gestures for various gestures may be defined by a manufacturer of the second device 104b. The processor 302 may modify the default reference gestures based on base gestures received from the server 106. The processor 302 may store default reference gestures and base gestures received from the server 106 in the memory 304.

In an embodiment, the processor 302 may compare a gesture input received from a second device user with reference base gestures. In an embodiment, the processor 302 may compare an input gesture with default reference gestures stored in the memory 304. Based on the comparison, the processor 302 may identify the input gesture. In an embodiment, the processor 302 may not be able to identify the input gesture based on the comparison with the default reference gestures. In such a case, the processor 302 may compare the input gesture with base gestures received from the server 106. Based on the comparison with base gestures, the processor 302 may determine whether the gesture performed by the second device user matches at least one of the plurality of variations of a pre-defined gesture. The processor 302 may identify the gesture performed by the second device user as the pre-defined gesture, when the processor 302 determines a match. For example, the processor 302 may compare a series of images captured by the camera 312 with reference images received from the server 106. Based on the comparison, the processor 302 may identify the gesture performed by the second device user.

Notwithstanding, the disclosure may not be so limited and the processor 302 may compare an input gesture with default reference gestures and/or base gestures received from the server 106, in any order, without limiting the scope of the disclosure. Further, the processor 302 may compare an input gesture with only one of default reference gestures and/or base gestures received from the server 106, without limiting the scope of the disclosure.

In an embodiment, the processor 302 may transmit an unknown input gesture to the server 106 to identify the input gesture. This may happen when the second device 104b is connected to the communication network 102. The server 106 may identify the unknown gesture, as described above with regard to FIG. 2. The processor 302 may receive information that identifies the unknown gesture, from the server 106. In an embodiment, the second device 104b may not be connected to the communication network 102. In such a case, the processor 302 may identify an unknown gesture based on comparison with reference gestures stored in the memory 304.

In an embodiment, the processor 302 may not be able to identify a gesture that exactly matches a gesture input by a second device user. In such a case, the processor 302 may identify the best match for the input gesture. The processor 302 may provide a message to the second device user to verify whether the best match identified by processor 302 corresponds to the input gesture. In an embodiment, the processor 302 may not be able to identify a gesture performed by a second device user, based on comparison with default reference gestures and/or base gestures received from the server 106. In such a case, the processor 302 may provide an error message to the second device user.

In an embodiment, the processor 302 may provide feedback to a second device user when the second device user performs a gesture. In an embodiment, the processor 302 may provide the feedback when a second device user learns a gesture. In an embodiment, the processor 302 may provide the feedback when a second device user performs a gesture incorrectly. For example, the processor 302 may determine that the third user 110c is waving a hand at a speed faster than that the processor 302 may recognize. In such a case, the processor 302 may provide feedback to the third user 110c to wave the hand at the required speed.

In an embodiment, the processor 302 may implement a device control operation associated with an input gesture. In an embodiment, a default map between a gesture and a device control operation to be implemented may be pre-defined by a manufacturer of the second device 104b. Such a map may be stored in the memory 304 of the second device 104b. In an embodiment, the processor 302 may allow a second device user to modify the default map. In an embodiment, a mapping between a gesture and a device control operation to be implemented may be defined by a second device user.

In an embodiment, the processor 302 may receive a default device control operation associated with a pre-defined gesture from the server 106. The processor 302 may implement the received default device control operation. When a second device user performs the pre-defined gesture, the processor 302 may execute the default device control operation. For example, the processor 302 may receive a channel change operation as a default device control operation that corresponds to a hand-waving gesture. In such a case, when the second user 110b, and/or the third user 110c, waves a hand to control the second device 104b (which is a television), the processor 302 may execute a channel change operation.

In an embodiment, the processor 302 may receive a base gesture profile for the second device 104b, from the server 106. A base gesture profile for the second device 104b may comprise one or more base gestures that correspond to one or more device control operations of the second device 104b. Such a base gesture profile is explained above with regard to FIG. 2. The processor 302 may implement the received base gesture profile, such that a second device user may control the second device 104b through gestures associated with the received base gesture profile. In an embodiment, the processor 302 may allow a second device user to modify a base gesture profile received from the server 106.

In an embodiment, the processor 302 may present a UI on a display of the second device 104b. The processor 302 may allow a second device user to provide an input to the second device 104b, via the UI. In an embodiment, a second device user may provide an input through a UI to verify a gesture identified by the second device 104b. In an embodiment, a second device user may provide an input through a UI to modify a base gesture, default device control operation, and/or a base gesture profile received from the server 106. In an embodiment, a second device user may provide an input through a UI to modify configuration settings of the second device 104b.

In an embodiment, the processor 302 may allow a second device user to access a website associated with the server 106 through a UI. The processor 302 may allow a second device user to configure, upload and/or restore a base gesture profile on the second device 104b through a website associated with the server 106.

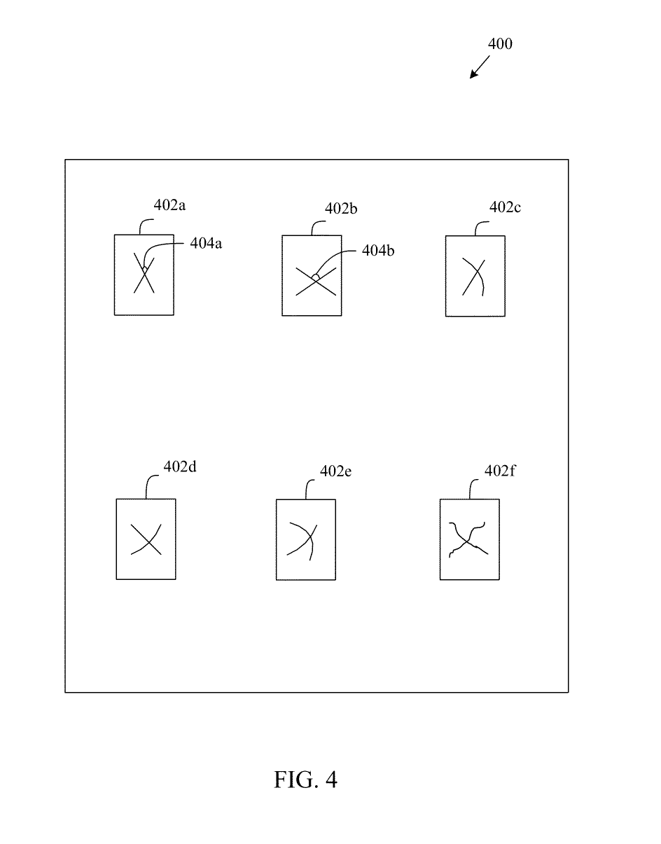

FIG. 4 illustrates an example of a base gesture associated with a gesture, in accordance with an embodiment of the disclosure. The example of FIG. 4 is explained in conjunction with the elements from FIG. 1, FIG. 2 and FIG. 3. The example of FIG. 4 has been explained by the use of a pattern “X” as the gesture. Notwithstanding, the disclosure may not be limited and the example of FIG. 4 may be applicable to any gesture, without limiting the scope of the disclosure.

With reference to FIG. 4, there is shown a base gesture 400 associated with gesture of drawing a pattern “X”. The base gesture 400 may include variations associated with drawing a pattern “X”, such as a first variation 402a, a second variation 402b, a third variation 402c, a fourth variation 402d, a fifth variation 402e and a sixth variation 402f. The first variation 402a, the second variation 402b, the third variation 402c, the fourth variation 402d, the fifth variation 402e and the sixth variation 402f are collectively referred to as variations 402. The variations 402 may indicate how the users 110 may draw the pattern “X”. For example, the first variation 402a, the second variation 402b, and the third variation 402c may correspond to the pattern “X” drawn by the first user 110a, the second user 110b and the third user 110c, respectively. Similarly, the fourth variation 402d, the fifth variation 402e and the sixth variation 402f may correspond to the pattern “X” drawn by the fourth user 110d at different times.

As shown in FIG. 4, the variations 402 may differ from each other. For example, an angle 404a, formed between two lines of the pattern “X” of the first variation 402a, may be smaller than an angle 404b, formed between two lines of the pattern “X” of the second variation 402b. Similarly, as compared to first variation 402a, the lines of the pattern “X” of the third variation 402c, the fourth variation 402d and the fifth variation 402e, are curved. In another example, the pattern “X” of the first variation 402a is formed using straight lines, while the pattern “X” of the sixth variation 402f is formed using waving lines. Notwithstanding, the disclosure may not be so limited and there may be other variations of the pattern “X”, without limiting the scope of the disclosure.

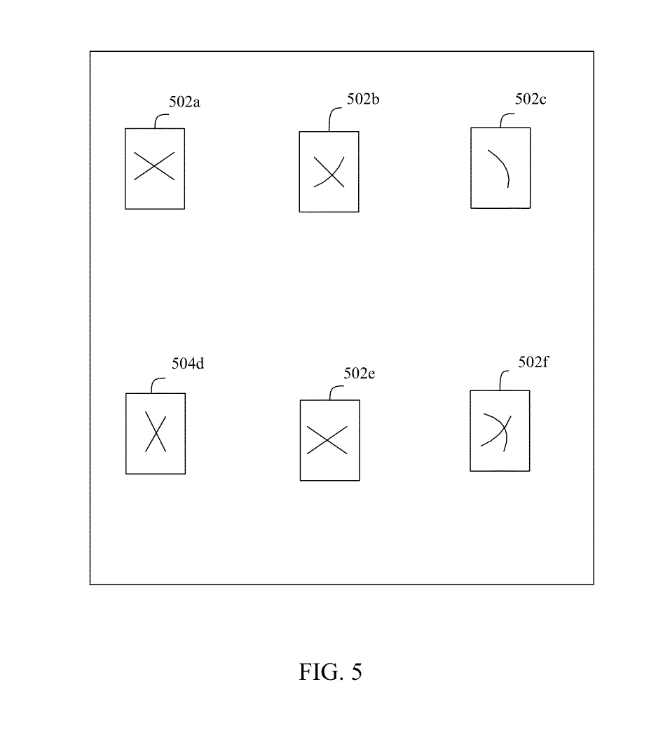

FIG. 5 illustrates an example of various gesture input to the devices 104 by the users 110, in accordance with an embodiment of the disclosure. The example of FIG. 5 is explained in conjunction with the elements from FIG. 1, FIG. 2, FIG. 3 and FIG. 4. The example of FIG. 5 has been explained by use of a pattern “X” as an input gesture. Notwithstanding, the disclosure may not be limited and the example of FIG. 5 may be applicable to any gesture, without limiting the scope of the disclosure.

With reference to FIG. 5, there is shown different, gestures performed by the users 110 to control the devices 104. The first user 110a may perform a first gesture 502a to control the first device 104a. Similarly, the second user 110b and the third user 110c may perform a second gesture 502b and a third gesture 502c, respectively, to control the second device 104b. Further, the fourth user 110d may perform a fourth gesture 502d, a fifth gesture 502e, and a sixth gesture 502f, to control the fourth device 104d, the fifth device 104e and the sixth device 104f, respectively. The first gesture 502a, the second gesture 502b, the third gesture 502c, the fourth gesture 502d, the fifth gesture 502e, and the sixth gesture 502f, are collectively referred to as gestures 502.

The devices 104 may transmit the gestures 502 to the server 106 for identification. The processor 202 may compare the gestures 502 with the variations 402 of the base gesture 400. Based on the comparison, the processor 202 may identify the gesture performed by the users 110. For example, based on comparison, the processor 202 may determine that the first gesture 502a matches the second variation 402b. Thus, the processor 202 may identify that the first gesture 502a corresponds to drawing a pattern “X”. The processor 202 may transmit information that identifies the first gesture 502a of the first device 104a. In another example, based on comparison, the processor 202 may determine that the third gesture 502c does not match any of the variations 402. Thus, the processor 202 may not be able to identify the third gesture 502c. The processor 202 may transmit an error message to the third device 104c. Similarly, the processor 202 may compare the second gesture 502b, the fourth gesture 502d, the fifth gesture 502e, and/or the sixth gesture 502f, to the variations 402. Based on the comparison, the processor 202 may determine that the second gesture 502b and the fourth gesture 502d match the fourth variation 402d and the first variation 402a, respectively. The processor 202 may determine that the fifth gesture 502e and the sixth gesture 502f match the second variation 402b, and the fifth variation 402e, respectively. The processor 202 may transmit information identifying the second gesture 502b, the fourth gesture 502d, the fifth gesture 502e, and/or the sixth gesture 502f, to the respective devices.

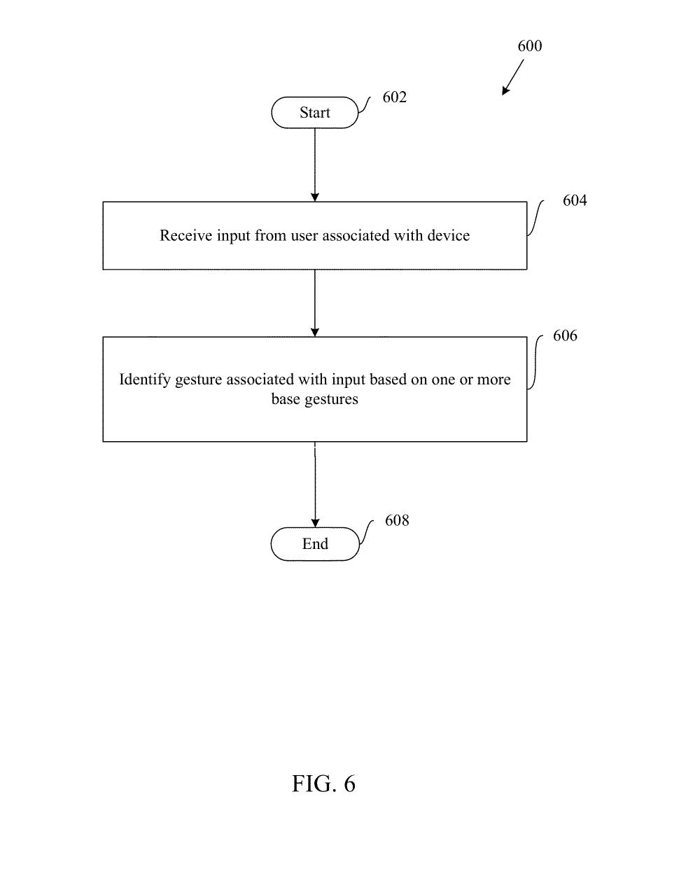

FIG. 6 is a flow chart illustrating exemplary steps for gesture recognition, in accordance with an embodiment of the disclosure. With reference to FIG. 6, there is shown a flow chart 600. The flow chart 600 is described in conjunction with FIGS. 1, 2, and 3. The method starts at step 602 and proceeds to step 604.

At step 604, an input may be received from a user associated with one of the devices 104. At step 606, a gesture associated with the received input may be identified based on one or more base gestures. Each of the one or more base gestures encapsulates a plurality of variations of a pre-defined gesture for a plurality of users associated with the devices 104. Control then passes to end step 608.

In accordance with an embodiment of the disclosure, a network environment, such as the network environment 100 (FIG. 1), may comprise a network, such as the communication network 102 (FIG. 1). The network may be capable of communicatively coupling one or more devices 104 (FIG. 1) and a server 106 (FIG. 1). The server 106 may comprise one or more processors, such as a processor 202 (FIG. 2). The one or more processors, such as the processor 202, may be operable to receive a plurality of gesture profiles associated with each of the one or more devices 104. The one or more processors, such as the processor 202, may be operable to determine a base gesture, such as a base gesture 400 (FIG. 4), for a pre-defined gesture based on the received plurality of gesture profiles. The base gesture, such as the base gesture 400, may encapsulate a plurality of variations, such as variations 402 (FIG. 4), of the pre-defined gesture for a plurality of users 110 (FIG. 1) associated with the one or more devices 104 (FIG. 1). The pre-defined gesture may comprise a non-audio gesture.

The one or more processors, such as the processor 202, may be operable to compare a gesture, such as a first gesture 502a (FIG. 5), performed by a user associated with one or more devices of the plurality of devices 104 with the plurality of variations 402. The one or more processors, such as the processor 202, may be operable to determine the performed gesture, such as the first gesture 502a, as the pre-defined gesture when the performed gesture matches at least one of the plurality of variations 402.

The one or more processors, such as the processor 202, may be operable to determine a base device control operation associated with the pre-defined gesture based on the received plurality of gesture profiles. The one or more processors, such as the processor 202, may be operable to set the base device control operation as a default device control operation that corresponds to the base gesture 400 for one or more devices of the plurality of devices 104. The one or more processors, such as the processor 202, may be operable to dynamically update the base gesture 400 based on change in one or more of the received plurality of gesture profiles. The one or more processors, such as the processor 202, may be operable to determine a variation of the pre-defined gesture different from the plurality of variations of the pre-defined gesture. The one or more processors, such as the processor 202, may be operable to dynamically update the base gesture for the pre-defined gesture based on the determined variation.

The one or more processors, such as the processor 202, may be operable to determine a base gesture profile for each of the plurality of devices 104. The base gesture profile comprises one or more base gestures, such as the base gesture 400, which correspond to one or more device control operations of each of the plurality of devices 104.

The one or more processors, such as the processor 202, may be operable to allow a user, such as a first user 110a (FIG. 1), to upload and/or restore the base gesture profile on each of the plurality of devices 104 through a web site associated with the server 106. The one or more processors, such as the processor 202, may be operable to publish the base gesture 400 and/or the base gesture profile on the web site. The non-audio gesture may comprise touch-based gestures and/or visual-based gestures.

Various embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for recognizing a gesture based on gestures associated with a plurality of users. The at least one code section in a server may cause gesture recognition in a communication network. The communication network may comprise a plurality of devices communicatively coupled to the server. An input is received by one of the plurality of devices from a user associated with the device. A gesture associated with the input may be identified based on one or more base gestures received from the server. Each of the one or more base gestures may encapsulate a plurality of variations of a pre-defined gesture for a plurality of users associated with the plurality of devices.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for gesture recognition, said system comprising:
in a server communicatively coupled to a plurality of devices, said server comprising one or more processors operable to:
receive a plurality of gesture profiles associated with each of said plurality of devices; and
determine a base gesture for a pre-defined gesture based on said received plurality of gesture profiles, wherein said base gesture encapsulates a plurality of variations of said pre-defined gesture for a plurality of users associated with said plurality of devices, wherein said pre-defined gesture comprises a non-audio gesture.

2. The system of claim 1, wherein said one or more processors are operable to:
compare a gesture performed by a user associated with one or more devices of said plurality of devices with said plurality of variations; and
determine said performed gesture as said pre-defined gesture when said performed gesture matches at least one of said plurality of variations.

3. The system of claim 1, wherein said one or more processors are operable to determine a base device control operation associated with said pre-defined gesture based on said received plurality of gesture profiles.

4. The system of claim 3, wherein said one or more processors are operable to set said base device control operation as a default device control operation corresponding to said base gesture for one or more devices of said plurality of devices.

5. The system of claim 1, wherein said one or more processors are operable to dynamically update said base gesture based on change in one or more of said received plurality of gesture profiles.

6. The system of claim 1, wherein said one or more processors are operable to:
determine a variation of said pre-defined gesture different from said plurality of variations of said pre-defined gesture; and
dynamically update said base gesture for said pre-defined gesture based on said determined variation.

7. The system of claim 1, wherein said one or more processors are operable to determine a base gesture profile for each of said plurality of devices, wherein said base gesture profile comprises one or more base gestures corresponding to one or more device control operations of each of said plurality of devices.

8. The system of claim 7, wherein said one or more processors are operable to allow a user to upload and/or restore said base gesture profile on each of said plurality of devices through a web site associated with said server.

9. The system of claim 8, wherein said one or more processors are operable to publish said base gesture and/or said base gesture profile on said web site.

10. The system of claim 1, wherein said non-audio gesture comprises touch-based gestures and/or visual-based gestures.

11. A method for gesture recognition, said method comprising:
receiving an input from a user associated with a device; and
identifying a gesture associated with said received input based on one or more base gestures, wherein each of said one or more base gestures encapsulates a plurality of variations of a pre-defined gesture for a plurality of users associated with said plurality of devices, wherein said gesture associated with said received input comprises a non-audio gesture.

12. The method of claim 11, further comprising identifying said gesture as said pre-defined gesture when said received input matches at least one of said plurality of variations.

13. The method of claim 11, wherein said device receives said one or more base gestures from a server communicatively coupled to said device.

14. The method of claim 13, further comprising:
determining a change in one or more parameters associated with said gesture based on said received input; and
transmitting said determined change to a server, wherein said server updates said one or more base gestures based on said determined change.

15. The method of claim 13, further comprising:
determining one or more gesture profiles for one or more users associated with said device; and
transmitting said determined one or more gesture profiles to said server, wherein said server determines said one or more base gestures based on said one or more gesture profiles.

16. The method of claim 13, further comprising receiving a base gesture profile from said server, wherein said received base gesture profile comprises a base gesture for each device control operation associated with said device.

17. The method of claim 13, further comprising enabling said user to configure, upload and/or restore a gesture profile corresponding to said user on said device through said server.

18. The method of claim 13, further comprising setting a base gesture of said received one or more base gestures as a default gesture for a pre-defined device control operation, wherein said pre-defined device control operation is determined by said server based on a plurality of gesture profiles for said plurality of users.

19. A method for gesture recognition, said method comprising:
in a server communicatively coupled to a plurality of devices:
receiving a plurality of gesture profiles associated with each of said plurality of devices; and
determining a base gesture for a pre-defined gesture based on said received plurality of gesture profiles, wherein said base gesture encapsulates a plurality of variations of said pre-defined gesture for a plurality of users associated with said plurality of devices, wherein said pre-defined gesture comprises a non-audio gesture.

20. The method of claim 19, further comprising:
comparing a gesture performed by a user associated with one or more devices of said plurality of devices with said plurality of variations; and
determining said performed gesture as said pre-defined gesture when said performed gesture matches at least one of said plurality of variations.

21. The method of claim 19, further comprising determining a base device control operation associated with said pre-defined gesture based on said received plurality of gesture profiles.

22. The method of claim 19, further comprising determining a base gesture profile for each of said plurality of devices, wherein said base gesture profile comprises one or more base gestures corresponding to one or more device control operations of each of said plurality of devices.
